(19) United States
(12) Patent Application Publication
(10) Pub. No.: US 2021/0278036 A1
(43) Pub. Date: Sep. 9, 2021

(54) RACKING BRACKET AND CONNECTOR

(71) Applicant: Process Displays LLC, Minneapolis, MN (US)

(72) Inventor: Rick D. Anderson, Minneapolis, MN (US)

(21) Appl. No.: 17/097,631

(22) Filed: Nov. 13, 2020

Related U.S. Application Data
(60) Provisional application No. 62/934,764, filed on Nov. 13, 2019.

(51) Int. Cl. F16M 13/02; F16B 5/00

(52) U.S. Cl. CPC F16M 13/022; F16B 5/0056

(57) ABSTRACT

The present invention relates to a lighted display. In particular, to a circular frame having a lighted display attached to the center.

### BACKGROUND OF THE INVENTION

### Field of the Invention

The present invention relates to a multi-purpose bracket and connector.

### Background

Racking brackets, or pallet racks, are commonly used frames in a number of environments. They can be found in retail establishments, warehouses, and in homes was well. As shown in FIG. 1, pallet racks are generally comprised of four vertical columns or posts, and a plurality of horizontal braces, and beam connectors to form the frame. Wire decking or other material can be used to create shelves for the storing various material.

The columns are hollow and typically have keyholes along the length of many or all of the sides. Frequently, the columns are three sided, or have an open slot or channel along the length of the column for access to the interior (see FIG. 6), which allows for access to the back side of the keyholes when attaching the braces and beams. The braces or beam connectors are connected to the columns with brackets or fittings that align with the keyholes, or they can be welded to the columns.

While this configuration has been around for decades, the ability to attach secondary brackets and the like is limited. Thus, a need exists for a bracket that can attach to a pallet bracket.

### BRIEF DESCRIPTION OF THE FIGURES

FIG. 1 is a perspective view of two pallet racks.

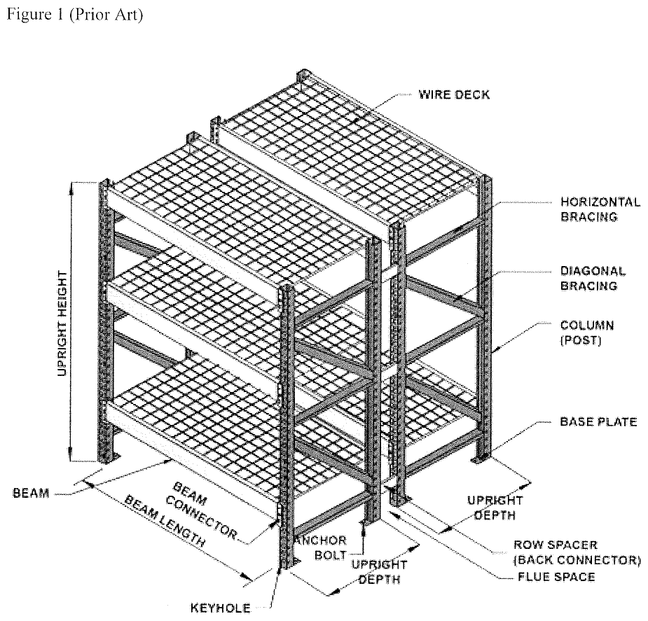

FIG. 2 shows perspective views of the front and back of a bracket and connector.

FIG. 3 is a perspective view of the bracket with the connector removed.

FIG. 4 shows multiples of the bracket.

FIG. 5 shows multiple view of the connector.

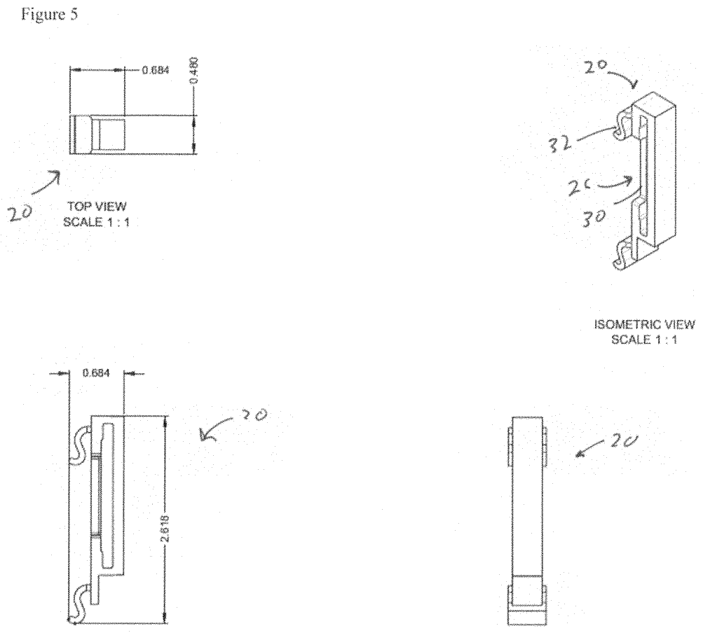

FIG. 6 is a perspective view of the bracket secured to keyholes of a column of the pallet rack.

FIG. 7 shows perspective views of the front and back of another bracket and connector.

FIG. 8 is a perspective view of the bracket with the connector removed.

FIG. 9 is a perspective view of the bracket.

FIG. 10 is a perspective view of the bracket attacked to a brace of the pallet rack.

FIG. 11 shows multiple view of a screw.

### DETAILED DESCRIPTION OF THE INVENTION

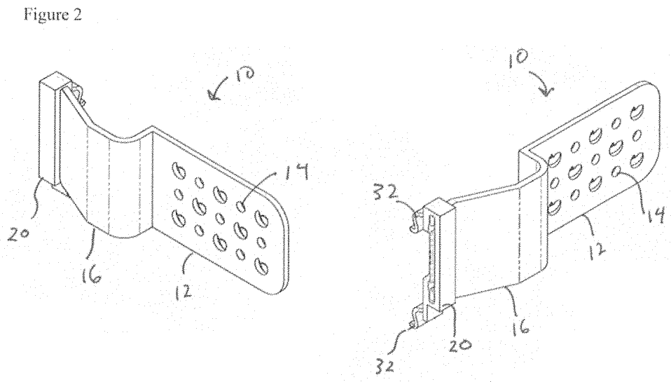

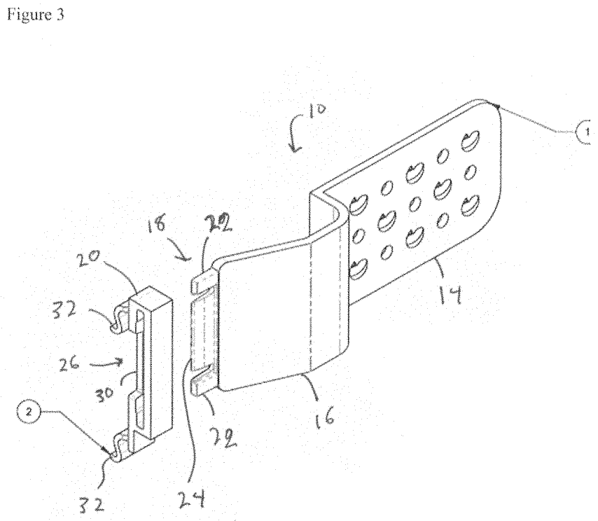

The present invention relates to a bracket for use with a pallet rack, as shown in the Figures. FIG. 2 shows a bracket 10. The bracket 10 comprises a flange 12 having a plurality of spaced apart holes 14. The holes 14 have various shapes as explained below. The bracket 10 also comprises a curved body 16 and a clip 18 (see FIG. 3). The body 16 connects the flange 12 and the clip 18. Also, shown is a connector 20 that releasably fits over the clip 18 of the bracket 10 (see FIG. 3).

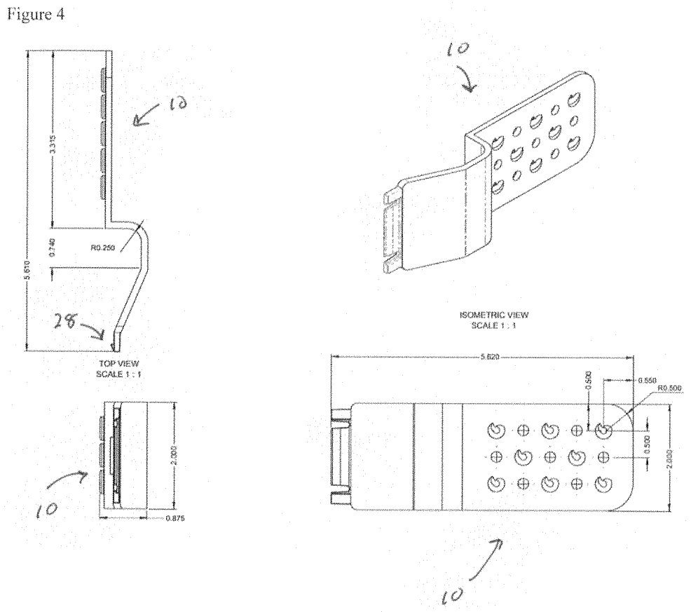

The clip 18 includes two posts 22 on each side of a tongue 24 located therebetween. The posts 22 and tongue 24 fit into a correspondingly shaped slot 26 in the connector 20. In particular, the tongue 24 includes a barb 28 (see FIG. 4) on the end. The barb 28 snap fits over a bar 30 of the connector 20 thereby securing the connector 20 firmly in place; however, the parts can be separated.

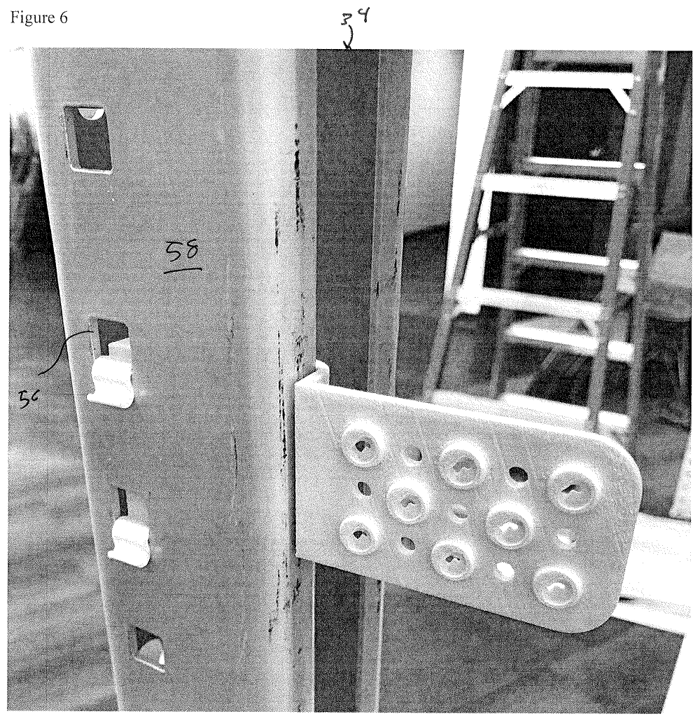

The connector 20 includes two S-shaped hooks 32 that fit into the keyholes 56 of the column 58 (see FIG. 6), while the body 16 of the bracket 10 fits around the inside of the column 58 through the slot/channel 34 in the column 58. The connector 20 is universal in that the bracket 10 can connect to the connector 20 in either direction. The bracket 10 can thus rotate 180 degrees from the position shown in FIG. 6, such that the bracket 10 attaches to either the right or left side columns 58 of the pallet rack.

Additionally, the connector 20 can fit into keyholes 56 of different shapes, whether square as show in FIG. 6, or teardrop shaped, or other shapes as well.

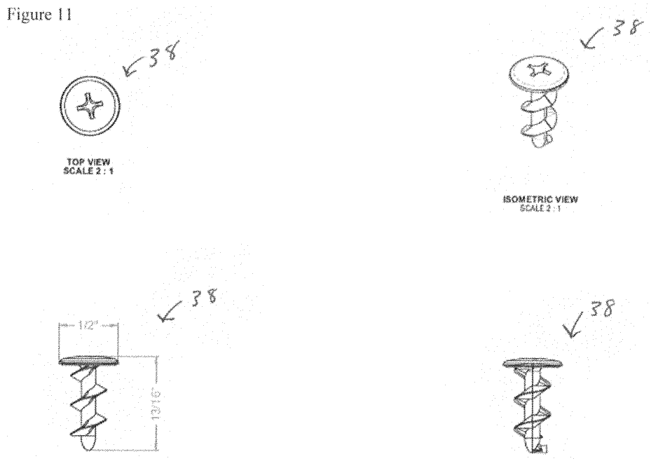

The flange 12 of the bracket 10 includes several holes 14. The holes include several slotted holes 36 that can receive the threaded screws 38 shown in FIG. 11. The screws 38 can be used to secure items to the bracket 10 such as displays, signs, hardware items that can be used to store or display items, or any number of other items. The circular holes 14 can be used to secure any other type of fastener, such as a nut and bolt and the like.

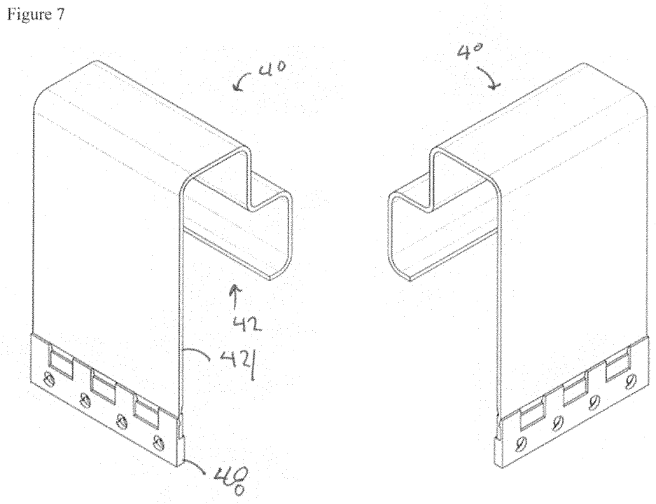

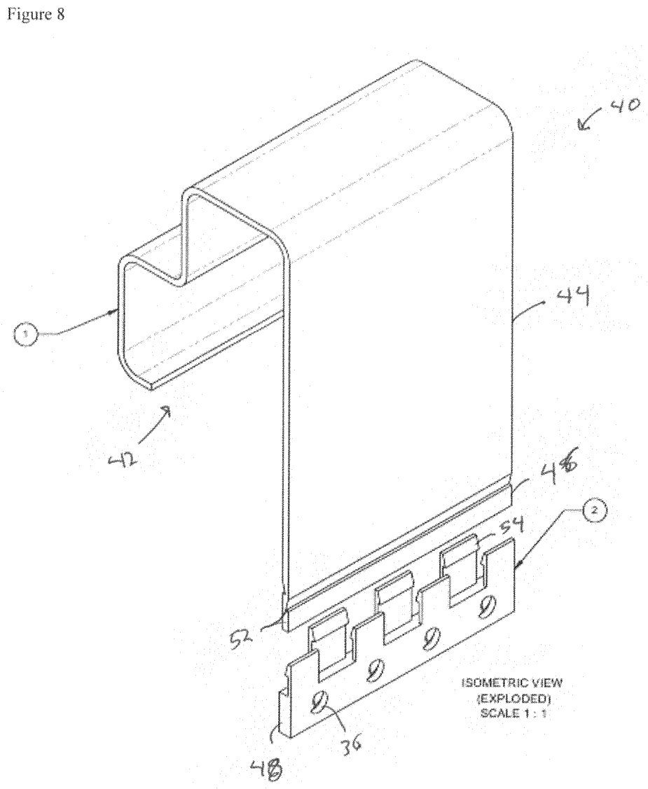

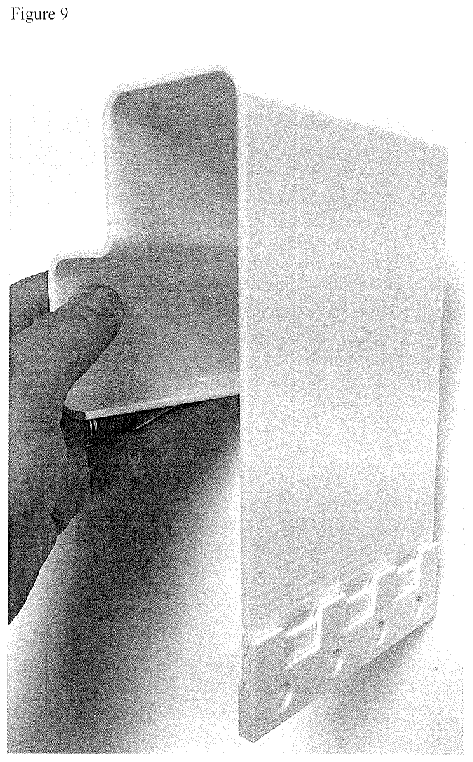

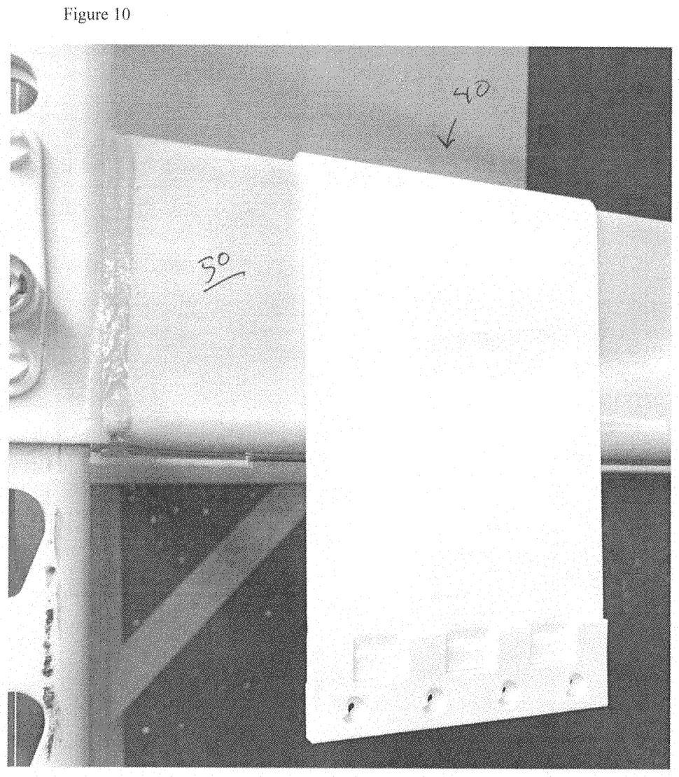

FIGS. 7-10 show another bracket 40 of the present invention. The bracket 40 includes a holder 42, a body 44, and a clip 46. The bracket 40 uses a connector 48. The holder 42 allows the bracket 40 to secure over a brace or beam 50 of the pallet rack, as shown in FIG. 10. The holder 42 has two configurations so that the bracket 40 can connect in two orientations. This allows the body 44 of the bracket 40 to be aligned in a vertical or horizontal orientation. The clip 46 of bracket 40 includes a ridge 52, and barbs 54 on the connector 48 snap fit over the ridge 52 to secure the connector 48 to the bracket 40. The connector 48 can be removed as well. The connector includes slotted holes 36 to receive screws 38 of the type shown in FIG. 11.

The above specification and accompanying Figures are for illustrative use only. The scope of the present invention is defined by the following claims. The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A bracket for connection to a post, comprising:
a body;
a clip connected to the body; and
a connector for releasable securement to the clip.

2. The bracket of claim 1 where the body connects to the post and is curved to conform to the shape of the body.

3. The bracket of claim 1 where the connector releaseably secures to the post.

4. The bracket of claim 3 where the connector contains hooks that secure to keyholes in the post.

5. The bracket of claim 1 further comprising a flange connected to the body.

6. The bracket of claim 5 where the flange comprises one or more holes.

7. The bracket of claim 5 further comprising a plurality of holes, where some of the holes are threaded and some are not.

8. The bracket of claim 1 where the clip includes a tongue that secures into a slot in the connector, allowing the connector and clip to releaseably secure.

9. The bracket of claim 8 where the tongue has a barb for capture by the slot of the connector.

10. The bracket of claim 3 where the hooks are S-shaped to provide a resilient biasing force to retain the hooks in the keyholes.

11. A bracket for connection to keyholes in a post, comprising:
a flange having a plurality of holes, where some of the holes are threaded and some are not;
a body connected to the flange, where the body is curved to conform to the shape of the post and fits in a slot in the post;
a clip and connected to the body, the clip having two posts and a barbed tongue; and
a connector having a slot for releasable connection with the clip where by the posts and tongue fit into the slot, the connector having contains S-shaped hooks that secure to keyholes in the post with a resilient biasing force

12. The bracket of claim 1 having a holder for securing to the post.

13. The bracket of claim 12, where the holder has two channels one for securing the bracket in a vertical orientation, and the other for securing the bracket in a horizontal orientation.

14. The bracket of claim 12 where the clip comprises a ridged shelf

15. The bracket of claim 14 where the connector has barbs that releaseably secures to the ridged shelf of the clip.

16. The bracket of claim 15 where the connector has threaded holes.
